(19) United States
(12) Patent Application Publication
(10) Pub. No.: US 2022/0300575 A1
(43) Pub. Date: Sep. 22, 2022

(54) DETERMINING TRIANGLES IN GRAPH DATA STRUCTURES USING CROSSPOINT ARRAY

(71) Applicants: International Business Machines Corporation, Armonk, NY (US); Ramot at Tel Aviv University Ltd., Tel Aviv (IL)

(72) Inventors: Vasileios Kalantzis, White Plains, NY (US); Shashanka Ubaru, Ossining, NY (US); Haim Avron, Tel Aviv (IL); Lior Horesh, North Salem, NY (US)

(21) Appl. No.: 17/207,912

(22) Filed: Mar. 22, 2021

(51) Int. Cl. G06F 17/16; G06F 16/901; G06F 16/22; G06F 16/23

(52) U.S. Cl. CPC G06F 17/16; G06F 16/9024; G06F 16/2237; G06F 16/2379

(57) ABSTRACT

Techniques for determining a count of triangles (tr) in a graph data structure using a crosspoint array is described. An adjacency matrix (a) representing the graph is mapped to the crosspoint array by configuring resistance values of crosspoint devices in the array. The count of triangles is initialized to zero (tr=0), and iteratively updated. The updating includes generating a first vector (x1) stochastically to include digital values in a predetermined range, which are converted into the voltage values. A multiplication of the adjacency matrix and the first vector (ax1) is computed using the crosspoint array. A second voltage vector (z1=ax1) is generated that includes voltage values representing the multiplication result. The adjacency matrix and the second voltage vector (z2=az1) are multiplied using the crosspoint array. The computer updates the number of triangles in the graph data structure as tr=tr+Z1^{T}.

### BACKGROUND

The present invention relates in general to computing technology and relates more particularly to computing technology configured to analyze graph data structures using crosspoint arrays.

Triangle counting (i.e., cliques of size three) is a key primitive in graph analysis with a wide range of applications in various fields, particularly computing technology. For example, determining the count of triangles in a graph data structure can facilitate spam/anomaly detection, link recommendation, degeneracy estimation, and query optimization. Further, computing various parameters used for analyzing large networks, such as communication networks, social media networks, etc., is based on the count of triangles. Such parameters can include clustering coefficient, transitivity ratio, and triangle connectivity, based on the count of triangles.

### SUMMARY

According to one or more embodiments of the present invention, a computer-implemented method for determining a count of triangles (TR) in a graph data structure using a crosspoint array is described. The computer-implemented method includes mapping, by a computer, to the crosspoint array, an adjacency matrix (A) that represents at least a portion of a graph data structure, where the crosspoint array may include a plurality of crosspoint devices respectively corresponding to a plurality of values in the adjacency matrix, and the mapping may include configuring resistance value of a crosspoint device according to a value at a corresponding position in the adjacency matrix. The computer-implemented method further includes setting, by the computer, the count of triangles in the graph data structure to zero (TR=0). The computer-implemented method further includes updating, by the computer, the count of triangles using the crosspoint array. The updating includes generating, by the computer, a first voltage vector (V₁) using a stochastic operation, the first voltage vector comprising a plurality of voltage values. The updating further includes computing, by the computer, a multiplication of the adjacency matrix and the first voltage vector by applying the voltage values from the first voltage vector as input to the crosspoint array, wherein the result of the multiplication is a second voltage vector (Z₁=AV₁). The updating further includes computing, by the computer, a multiplication of the adjacency matrix and the second voltage vector (Z₂=AZ₁) by applying the voltage values from the second voltage vector as input to the crosspoint array. The updating further includes updating, by the computer, the count of triangles in the graph data structure as TR=TR+Z₁^{T}Z₂/6.

According to one or more embodiments of the present invention, a system includes a crosspoint array, and a computer coupled with the crosspoint array. The computer performs a method for determining a number of triangles (TR) in graph data structures. The method includes mapping to the crosspoint array, an adjacency matrix (A) that represents at least a portion of a graph data structure, wherein the crosspoint array comprises a plurality of crosspoint devices respectively corresponding to a plurality of values in the adjacency matrix, and the mapping comprises configuring resistance value of a crosspoint device according to a value at a corresponding position in the adjacency matrix. The method further includes setting a count of triangles in the graph data structure to zero (TR=0). The method further includes updating, by the computer, the count of triangles using the crosspoint array. The updating includes generating a first voltage vector (V1) using a stochastic operation, the first voltage vector comprising a plurality of voltage values. The updating further includes computing a multiplication of the adjacency matrix and the first voltage vector by applying the voltage values from the first voltage vector as input to the crosspoint array, wherein the result of the multiplication is a second voltage vector (Z1=AV1). The updating further includes computing a multiplication of the adjacency matrix and the second voltage vector (Z2=AZ1) by applying the voltage values from the second voltage vector as input to the crosspoint array. The updating further includes updating the count of triangles in the graph data structure as TR=TR+Z₁^{T}Z₂/6.

According to one or more embodiments of the present invention, a computer program product includes a memory device having computer-executable instructions stored thereon, the computer-executable instructions when executed by one or more processing units cause the one or more processing units to perform a method for determining a number of triangles (TR) in a graph data structures. The method includes mapping to the crosspoint array, an adjacency matrix (A) that represents at least a portion of a graph data structure, wherein the crosspoint array comprises a plurality of crosspoint devices respectively corresponding to a plurality of values in the adjacency matrix, and the mapping comprises configuring resistance value of a crosspoint device according to a value at a corresponding position in the adjacency matrix. The method further includes setting a count of triangles in the graph data structure to zero (TR=0). The method further includes updating, by the computer, the count of triangles using the crosspoint array. The updating includes generating a first voltage vector (V1) using a stochastic operation, the first voltage vector comprising a plurality of voltage values. The updating further includes computing a multiplication of the adjacency matrix and the first voltage vector by applying the voltage values from the first voltage vector as input to the crosspoint array, wherein the result of the multiplication is a second voltage vector (Z1=AV1). The updating further includes computing a multiplication of the adjacency matrix and the second voltage vector (Z2=AZ1) by applying the voltage values from the second voltage vector as input to the crosspoint array. The updating further includes updating the count of triangles in the graph data structure as TR=TR+Z₁^{T}Z₂/6.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts an example scenario of a graph data structure with triangles according to one or more embodiments of the present invention;

FIG. 2 depicts a block diagram of a system for parallelizing estimation of the number of triangles in graph data structures according to one or more embodiments of the present invention;

FIG. 3 depicts an example matrix-vector product being performed using a crosspoint array according to one or more embodiments of the present invention;

FIG. 4 depicts a flowchart of a method for counting triangles in a graph data structure using analog hardware (e.g., a crosspoint array) according to one or more embodiments of the present invention;

FIG. 5 depicts a flowchart of a method for counting triangles in a graph data structure using analog hardware (e.g., a crosspoint array) according to one or more embodiments of the present invention; and

FIG. 6 depicts a digital computer in accordance with an embodiment.

The diagrams depicted herein are illustrative. There can be many variations to the diagram or the operations described therein without departing from the spirit of the invention. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Exemplary embodiments of the present invention relate to, among other things, devices, systems, methods, computer-readable media, techniques, and methodologies for using crosspoint arrays to parallelize approximation of triangles in graph data structures.

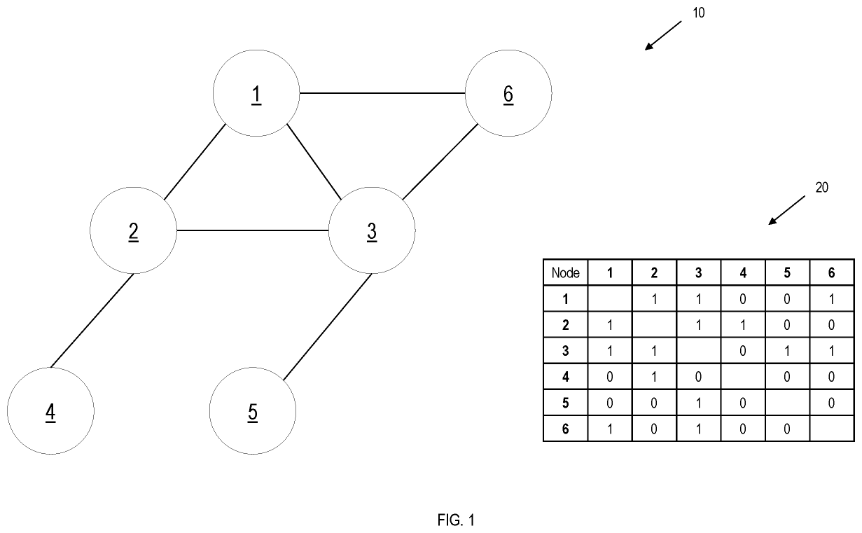

FIG. 1 depicts an example scenario of a graph data structure with triangles. A graph G 10 is shown, including nodes 1, 2, 3, 4, 5, and 6. In other scenarios, the graph data structure can include a different number of nodes from what is depicted. Additionally, the nodes of the graph G 10 can be connected differently from what is depicted.

As used herein, a “triangle” is a set of three vertices, i.e., nodes in the graph G 10, such that any two of the vertices are connected by an edge of the graph G 10 (3-clique). In the example depicted in FIG. 1, nodes 1, 2, and 3 form a triangle; also, nodes 1, 3, and 6 form a triangle. In the examples described herein, the graph data structure G 10 can be represented by an adjacency matrix A 20. The adjacency matrix A∈{0,1}^{n×n} represents the edges between the vertices by nonzero entries, where n is the number of nodes in G 10. Let nnz(A) denote the number of nonzero entries (i.e., edges).

The number of triangles in graph G 10 can be expressed as:

⅙tr(A³⁾⁼⅙Σᵢ₌₁ⁿAᵢᵢ³

Various existing solutions are available to count the triangles in graph G 10. At present, the known fastest algorithm to count the exact number of triangles is based on matrix multiplication and has a running complexity of the order O(nnz(A)^{1.41}) and memory complexity of the order O(n²). The memory complexity of the matrix-based approach is prohibitive for large graphs, and thus never used in practice. Practical alternatives, e.g., algorithms such as NodeIterator, compute the number of triangles in G 10, at a running complexity of the order O(nnz(A)^{1.5}). Now, it should be noted that in practical applications, the graph G 10 is much larger than the example graph shown in FIG. 1. For example, graph G 10, such as a telecommunications network, or a social media network, includes millions of nodes with an even larger number of edges. Hence, the order of execution of the existing algorithms to be substantially large. The number of nodes and edges makes it impractical, if not impossible, for the count of triangles in G 10 to be determined by a human in a mental process or using pen and paper. Further, it should be noted that G 10 is represented as A 20 when stored as the data structure and not as the visually depicted G 10. Hence, it is difficult to count the triangles manually.

Embodiments of the present invention provide technical solutions to this technical problem. Embodiments of the present invention facilitate a hybrid system that uses a crosspoint array to count (up to an approximation) the number of triangles in G 10 in O(n) (versus O(nnz(A)^{1.41}) of the fastest possible approach). Embodiments of the present invention improve efficiency by eliminating a bottleneck of indirect accessing associated with sparse matrix-vector products in digital devices when using the adjacency matrix A 20. The matrix-vector product is performed using specialized analog hardware (crosspoint array), thereby reducing both the complexity and system memory references when performing the product.

Embodiments of the present invention accordingly provide an improvement to computing technology by facilitating specialized hardware, an analog crosspoint array, to compute the number of triangles in a graph data structure, particularly that is represented using an adjacency matrix data structure. The number of triangles is determined faster than existing techniques because of analog hardware, for example, by reducing the number of memory references required in the existing techniques. Accordingly, embodiments of the present invention provide a practical application to a technical challenge in the field of computing technology.

Some existing techniques to address the technical challenge of counting triangles in a graph data structure include algorithms that approximate the number of triangles. Such techniques might be less costly, i.e., from the perspective of time-efficiency. However, such approximation's accuracy depends on several properties of the graph data structure being processed and is not applicable to any generic graph data structure. The existing generic algorithm to determine the count of triangles in any graph data structure is based on stochastic trace estimation which runs at O(nnz(A)). Nonetheless, even in this case, the estimator's variance might be too large, i.e., the accuracy of the approximation may be too low for some applications. Embodiments of the present invention overcome such technical challenges by using analog hardware to facilitate counting triangles of any generic graph data structure. Embodiments of the present invention can extract an approximation in linear complexity with respect to the number of vertices in the graph data structure instead of linear complexity with respect to the number of edges.

Further, embodiments of the present invention facilitate using the number of triangles in the graph data structure to be used for various additional practical applications, such as determining a clustering coefficient and determining a network's transitivity ratio.

In computing technology, particularly with graph data structures, a technical problem is community detection, i.e., identifying clusters of vertices in a graph data structure. This can be represented as a task of finding neighboring vertices in the graph data structure with high triangle participation. A “clustering coefficient” is used as an input for various known community detection algorithms. The clustering coefficient is a measure of the degree to which vertices in the graph data structure tend to cluster together. The clustering coefficient of a vertex v is expressed as:

$$C ( v ) := \frac{Δ ( v )}{\# of triplets involving v}$$

Here, Δ(v) is equal to the number of triangles in which the vertex v participates. Embodiments of the present invention facilitate improving the computation of the clustering coefficient by computing Δ(v) in an improved manner.

Further, in computing technology, “transitivity” is the overall probability for a network, represented as a graph data structure, to have adjacent nodes interconnected, thus revealing the existence of tightly connected communities (or clusters, subgroups, cliques). A transitivity ratio, which is a measure of the transitivity of the graph data structure, is computed as:

$$C := \frac{3 \times number of triangles}{\# of all triplets}$$

Computing the transitivity ratio of a network is frequently used in various e-commerce applications. For example, a high transitivity ratio implies similarity between nodes, thus creating marketing opportunities in e-commerce platforms (for example, suggest to a user p, what was suggested to users q and r if p, q, r, form a triangle in a graph of users). Embodiments of the present invention facilitate improving the computation of such e-commerce applications by improving the computation of the number of triangles, which is used for computing the transitivity ratio.

As noted, in computing technology, particularly in data mining and other fields that involve large amounts of data, graph data structures are ubiquitous. For example, the Internet, the World Wide Web (WWW), social networks, protein interaction networks and many other complicated structures are modeled as graphs to facilitate processing such data using computers.

In social networks, two main processes that generate triangles are homophily and transitivity. According to homophily, people tend to choose friends with similar characteristics to themselves, and per transitivity, friends of friends typically become friends too. Hence, social networks exhibit an abundance of triangles. Hence, to quantify several metrics associated with such social networks, the clustering coefficient and transitivity are used. For example, when using social networks for a marketing campaign, or any other information broadcast, knowing such metrics facilitates not only designing the campaign, but also, determining an optimal use of computing resources to perform the broadcast.

The clustering coefficient is used for detecting subsets of web pages with a common topic on the world wide web. Here, reciprocal links between pages indicate a mutual recognition/respect and then triangles due to their transitivity properties can be used to extend “seeds” to larger subsets of vertices with similar thematic structure in the Web graph. In other words, portions of the World Wide Web with high curvature indicate a common topic, allowing the authors to extract useful meta-information. Accordingly, when performing web-searches, the clustering coefficient, and in turn the number of triangles in the graph representing the world wide web with multitude webpages has to be determined.

In spam detection, the distribution of triangles among spam hosts and non-spam hosts can be used as a feature for classifying a given host as spam or non-spam. The same result holds also for web pages, i.e., the spam and non-spam triangle distributions differ at a detectable level using standard statistical tests from each other. Counting the triangles in the graph of connected hosts accordingly facilitates spam detection.

Embodiments of the present invention, accordingly, provide an improvement to computing technology. Further, embodiments of the present invention provide practical applications and improvements, such as e-commerce, network analysis, and other functions that use graph data structures. For example, embodiments of the present invention can improve computer-aided design, motif detection, microscopic evolution of networks, structural balance and status theory, spam detection, uncovering hidden thematic structures, among other fields of application of computing technology.

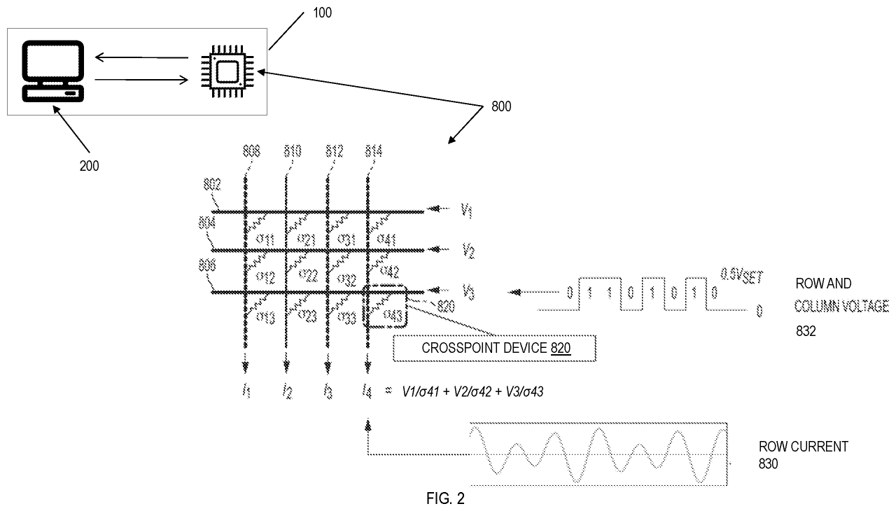

FIG. 2 depicts a block diagram of a system for parallelizing estimation of a number of triangles in graph data structures according to one or more embodiments of the present invention. System 100 includes a digital computing device (“computing device”) 200 and a crosspoint array 800. The crosspoint array 800 is specialized analog hardware that is used to perform matrix-vector products using voltages and current values. As described herein, the adjacency matrix A 20 representing the graph G 10 is converted and input into the crosspoint array 800 as voltage (or current) values to perform one or more computations for counting triangles in G 10.

As depicted in FIG. 2, the crosspoint array 800 is formed from a set of conductive row wires 802, 804, 806 and a set of conductive column wires 808, 810, 812, and 814 that intersect the set of conductive row wires 802, 804, and 806. The intersections between the set of row wires and the set of column wires are separated by crosspoint devices, which are shown in FIG. 2 as resistive elements each having its own adjustable/updateable resistive weight, depicted as σ11, σ21, σ31, σ41, σ12, σ22, σ32, σ42, σ13, σ23, σ33 and σ43, respectively. For ease of illustration, only one crosspoint device 820 is labeled with a reference number in FIG. 2. When performing a matrix multiplication, the conduction state (i.e., the stored weights) of the crosspoint device 820 can be read by applying a voltage across the crosspoint device 820 and measuring the current that passes through the crosspoint device 820.

Input voltages V1, V2, V3 are applied to row wires 802, 804, 806, respectively. An example input voltage 832 is depicted. Each column wire 808, 810, 812, 814 sums the currents I1, I2, I3, I4 generated by each crosspoint device along that column wire. For example, as shown in FIG. 2, the current I4 generated by column wire 814 is according to the equation I4=V1/ν41+V2/σ42 +V3/σ43. Thus, the crosspoint array 800 computes the matrix multiplication by multiplying the values stored in the crosspoint devices 820 by the row wire inputs, which are defined by voltages V1, V2, V3. For updating the values stored in the crosspoint devices 820, voltages are applied to column wires and row wires simultaneously, and the conductance values stored in the relevant crosspoint devices 820 all update in parallel. Accordingly, the multiplication and addition operations required to update the stored values are performed locally at each crosspoint device 820 of the crosspoint array 800 using the crosspoint device 820 itself plus the relevant row or column wire of array 800. Thus, in accordance with one or more embodiments of the present invention, no read-update-write cycles are required when using the crosspoint array 800. Each crosspoint device 820 in the crosspoint array 800 can have a different value, which can be configured.

It is understood that the number of crosspoint devices 820 in the crosspoint array 800 can be different from what is depicted in FIG. 2. Also, the Vₛₑₜ value can vary from what is illustrated to represent a 0 and/or 1 when inputting voltage and current values into the crosspoint array 800.

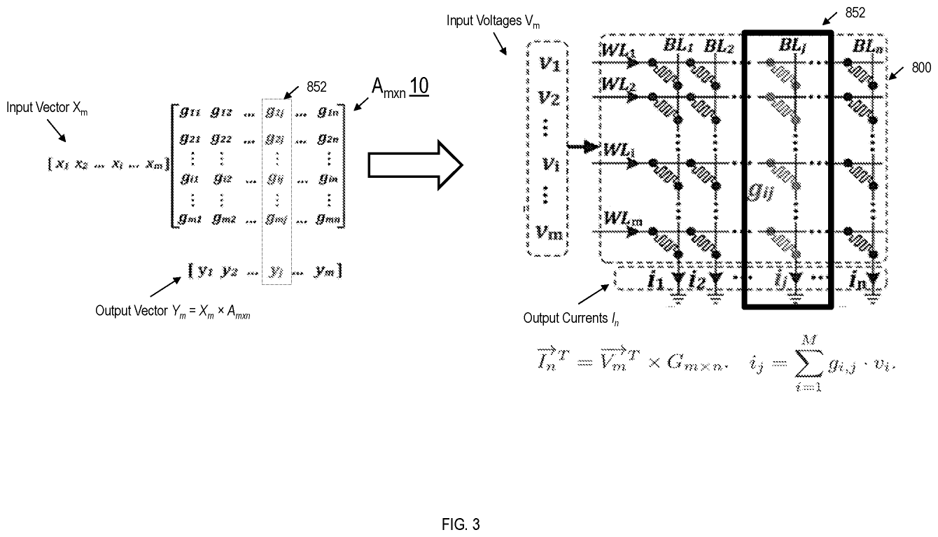

FIG. 3 depicts an example matrix-vector product being performed using a crosspoint array according to one or more embodiments of the present invention. In the depicted example, an input vector Xₘ is being multiplied with a matrix, such as the adjacency matrix A 10. Here, A 10 is shown to have dimensions m×n, where m and n are integer values. The result of the matrix-vector product is the output vector Yₘ=Xₘ×A_{m×n}. The adjacency matrix A 10 is mapped to the crosspoint array 800 by configuring the resistance (or conductance) values of each of the crosspoint device 820 according to the adjacency matrix A 10. The digital values of the adjacency matrix are converted into an analog form in this manner. The digital values in the input vector Xₘ are converted into analog values by generating a vector of input voltages Vₘ. The input voltages are applied to the crosspoint array 800 in a row-wise manner. The resulting output vector L at the crosspoint array 800 is represented by the electric current values that result by applying the input voltages Vₘ over the resistance values of the crosspoint devices 820. The electric current values are read and converted to corresponding digital values to obtain the matrix-vector product.

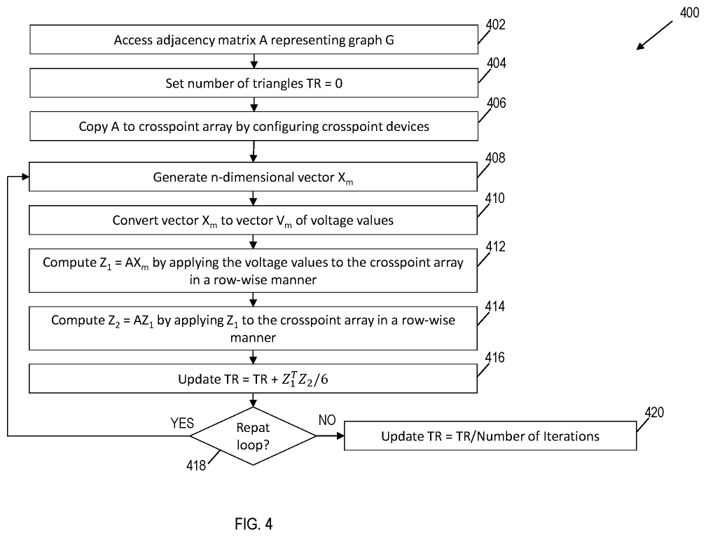

FIG. 4 depicts a flowchart of a method for counting triangles in a graph data structure using analog hardware according to one or more embodiments of the present invention. The method 400 uses Rademacher vectors to facilitate the counting of triangles using the crosspoint array 800. The digital computer 200 performs one or more operations described herein to facilitate using the crosspoint array 800 to count the number of triangles in the input graph G 10.

The method 400 includes accessing, by the digital computer 200, the adjacency matrix A 20 for G 10 with n nodes, at block 402. The digital computer 200 sets the count of triangles TR=0 (zero) initially, at block 404.

The digital computer 200 copies A 20 to the crosspoint array 800, at block 406. Copying A 20 to the crosspoint array 800 includes converting the digital values in the A 20 to the counterpart analog values in the form of resistance (or conductance) values at the corresponding crosspoint devices 820 in the crosspoint array 800. The adjacency matrix A 20, in one or more embodiments of the present invention, includes digital values representing 0s and 1s. The digital computer 200 uses predetermined resistance (or conductance) values to represent the digital values in the adjacency matrix A 20. The digital computer 200 configures the crosspoint devices 820 to have the counterpart resistance (or conductance) values.

Further, the digital computer 200 generates an n-dimensional vector Xₘ: x∈{−1,1}ⁿ, at block 408. The vector is generated using a stochastic operation, such as Rademacher distribution. Here, n is the number of nodes in the graph G 10. The vector Xₘ is converted to a corresponding vector Vₘ of voltage values, at block 410. The conversion includes representing the digital values in Xₘ based on a predetermined mapping between the digital values and a predetermined range of voltage values {0, Vₛₑₜ}.

The voltage values Vₘ are applied to the crosspoint array 800, each voltage value is applied to a corresponding row of the crosspoint array 800, at block 412. The crosspoint array 800 outputs a vector of electric current values Z₁=AXₘ. The digital computer 200 converts the electric current values output by the crosspoint array 800 into digital values using a predetermined range. For example, electric current values {0, Iₛₑₜ} are mapped to {0, 1}, such that an electric current value above a predetermined threshold (Iₛₑₜ) is considered to be a “1”, “0” otherwise.

Further, the digital computer 200 uses the crosspoint array 800 to compute Z₂=AZ₁, at block 414. This includes converting Z₁ to corresponding voltage values and applying these corresponding values to the crosspoint array 800 as input voltages in a row-wise manner. Here, Z₁ and Z₂ are output from the crosspoint array 800 that are converted to digital values by the digital computer 200 in one or more embodiments of the present invention.

The digital computer 200 updates the count of triangles as TR=TR+Z₁^{T}Z₂/6, at block 416.

The digital computer 200 repeats the above operations, starting from the generation of vector Xₘ to updating the count of triangles for a predetermined number of times, at block 418. The predetermined number of iterations is configurable in one or more embodiments of the present invention. Once the number of iterations is completed, the digital computer outputs the count of triangles in the input graph G 10 as TR=TR/number of iterations, at block 420.

As noted, in the method 400, the crosspoint array 800 facilitates computing the matrix-vector products (412, 414) in O(1), improving the method's runtime. The number of floating-point operations (FLOPS) if these operations are executed on a typical processor, such as the digital computer 200, is 4nnz(A). Accordingly, method 400 using one or more embodiments of the present invention provides a substantial improvement in execution efficiency.

The variance in the resulting count of triangles using method 400 can be expressed as 2(∥A∥_{F}²−Σᵢ₌₁ⁿAᵢᵢ²). Here, F represents the Frobenius norm.

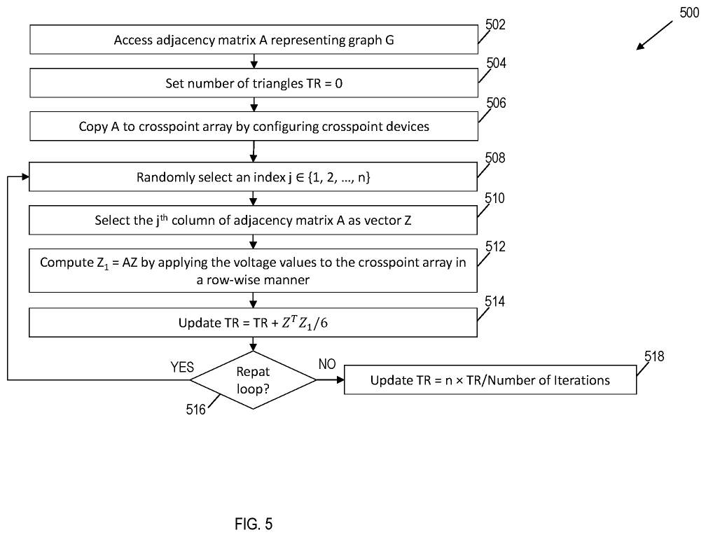

FIG. 5 depicts a flowchart of a method for counting triangles in a graph data structure using analog hardware according to one or more embodiments of the present invention. The method 500 uses unit vectors to facilitate the counting of triangles using the crosspoint array 800. The digital computer 200 performs one or more operations described herein to facilitate using the crosspoint array 800 to count the number of triangles in the input graph G 10.

The method 500 includes accessing, by the digital computer 200, the adjacency matrix A 20 for G 10 with n nodes, at block 502. The digital computer 200 sets the count of triangles TR=0 (zero) initially, at block 504. Further, the digital computer 200 copies A 20 to the crosspoint array 800, at block 506, as described herein.

Further, at block 508, the digital computer 200 selects an index j∈{1, 2, . . . , n} randomly. Here, n is the number of nodes in G 10. At block 510, the digital computer selects, from A 20, the vector Z=A(:, j), where j is the randomly selected index. At block 512, the digital computer 200 uses the crosspoint array 800 to compute Z₁=AZ by applying the vector Z as the input to the crosspoint array 800. Applying Z as input to the crosspoint array 800 includes converting the digital values in Z to corresponding voltage values using the predetermined voltage range {0, Vₛₑₜ} to map digital values to input voltage values.

Here, Z and Z₁ are output from the crosspoint array 800 that are converted to digital values by the digital computer 200 in one or more embodiments of the present invention. The digital computer 200 updates the count of triangles as TR=TR+Z^{T}Z₁/6, at block 514.

The digital computer 200 repeats the above operations, starting from selecting j to updating the count of triangles for a predetermined number of times, at block 516. The predetermined number of iterations is configurable in one or more embodiments of the present invention. Once the number of iterations is completed, the digital computer 200 outputs the count of triangles in the input graph G 10 as TR=n×TR/number of iterations, at block 518.

As noted, in the method 500, the crosspoint array 800 facilitates computing the matrix-vector products (512) in O(1), improving the method's runtime. The number of floating-point operations (FLOPS) if these operations are executed on a typical processor, such as the digital computer 200, is 2nnz(A). Accordingly, method 400 using one or more embodiments of the present invention provides a substantial improvement in execution efficiency.

The variance in the resulting count of triangles using method 400 can be expressed as nΣᵢ₌₁ⁿAᵢᵢ²−TR²(A).

Embodiments of the present invention provide a substantial improvement in runtime over existing techniques of counting triangles in a graph data structure. For example, in some experimental setups, with the input and output noise of the analog hardware being in the range of 1% to 6%, embodiments of the present invention have shown 21×-41× improvement in runtime and 75%-90% accuracy with nodes in the graph being in the thousands. In other experimental setups, with the input and output noise of the analog hardware being 1%, and the number of nodes in the graph being in the tens of thousands, an 8×-16× speedup in runtime was noted and 85%-95% accuracy.

Embodiments of the present invention accordingly provide improvements to computing technology, and further provide practical application to a technical challenge in the various fields where counting of triangles in a graph data structure is used. As described herein, performing such a count as a mental process is not practical, particularly with a large number of nodes in the graph data structure. Further, the graph data structure is represented in a digital form, such as an adjacency matrix.

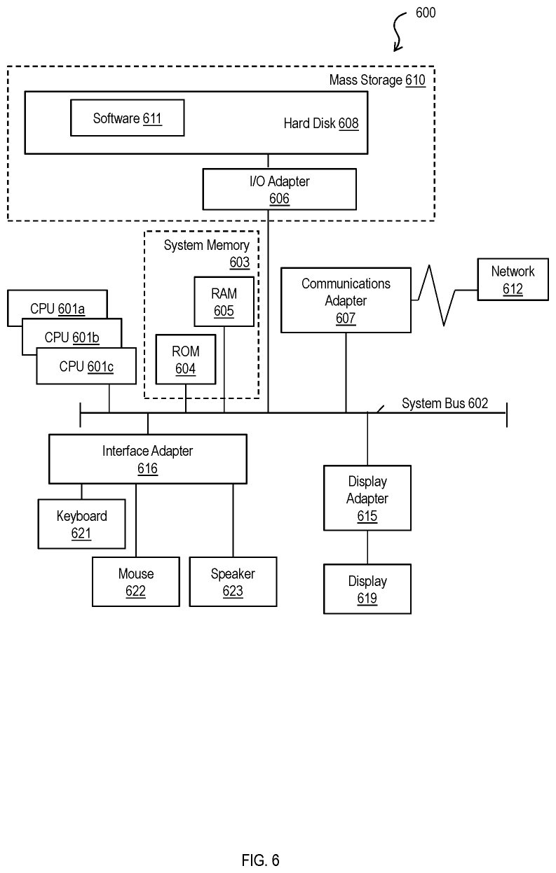

Turning now to FIG. 6, a computer system 600 is generally shown in accordance with an embodiment. The computer system 600 can be used as the digital computer 200 in one or more embodiments of the present invention. The computer system 600 can be an electronic, computer framework comprising and/or employing any number and combination of computing devices and networks utilizing various communication technologies, as described herein. The computer system 600 can be easily scalable, extensible, and modular, with the ability to change to different services or reconfigure some features independently of others. The computer system 600 may be, for example, a server, desktop computer, laptop computer, tablet computer, or smartphone. In some examples, computer system 600 may be a cloud computing node. Computer system 600 may be described in the general context of computer system executable instructions, such as program modules, being executed by a computer system. Generally, program modules may include routines, programs, objects, components, logic, data structures, and so on that perform particular tasks or implement particular abstract data types. Computer system 600 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 6, the computer system 600 has one or more central processing units (CPU(s)) 601a, 601b, 601c, etc. (collectively or generically referred to as processor(s) 601). The processors 601 can be a single-core processor, multi-core processor, computing cluster, or any number of other configurations. The processors 601, also referred to as processing circuits, are coupled via a system bus 602 to a system memory 603 and various other components. The system memory 603 can include a read only memory (ROM) 604 and a random access memory (RAM) 605. The ROM 604 is coupled to the system bus 602 and may include a basic input/output system (BIOS), which controls certain basic functions of the computer system 600. The RAM is read-write memory coupled to the system bus 602 for use by the processors 601. The system memory 603 provides temporary memory space for operations of said instructions during operation. The system memory 603 can include random access memory (RAM), read only memory, flash memory, or any other suitable memory systems.

The computer system 600 comprises an input/output (I/O) adapter 606 and a communications adapter 607 coupled to the system bus 602. The I/O adapter 606 may be a small computer system interface (SCSI) adapter that communicates with a hard disk 608 and/or any other similar component. The I/O adapter 606 and the hard disk 608 are collectively referred to herein as a mass storage 610.

Software 611 for execution on the computer system 600 may be stored in the mass storage 610. The mass storage 610 is an example of a tangible storage medium readable by the processors 601, where the software 611 is stored as instructions for execution by the processors 601 to cause the computer system 600 to operate, such as is described herein below with respect to the various Figures. Examples of computer program product and the execution of such instruction is discussed herein in more detail. The communications adapter 607 interconnects the system bus 602 with a network 612, which may be an outside network, enabling the computer system 600 to communicate with other such systems. In one embodiment, a portion of the system memory 603 and the mass storage 610 collectively store an operating system, which may be any appropriate operating system, such as the z/OS or AIX operating system from IBM Corporation, to coordinate the functions of the various components shown in FIG. 6.

Additional input/output devices are shown as connected to the system bus 602 via a display adapter 615 and an interface adapter 616 and. In one embodiment, the adapters 606, 607, 615, and 616 may be connected to one or more I/O buses that are connected to the system bus 602 via an intermediate bus bridge (not shown). A display 619 (e.g., a screen or a display monitor) is connected to the system bus 602 by a display adapter 615, which may include a graphics controller to improve the performance of graphics intensive applications and a video controller. A keyboard 621, a mouse 622, a speaker 623, etc. can be interconnected to the system bus 602 via the interface adapter 616, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 6, the computer system 600 includes processing capability in the form of the processors 601, and, storage capability including the system memory 603 and the mass storage 610, input means such as the keyboard 621 and the mouse 622, and output capability including the speaker 623 and the display 619.

In some embodiments, the communications adapter 607 can transmit data using any suitable interface or protocol, such as the internet small computer system interface, among others. The network 612 may be a cellular network, a radio network, a wide area network (WAN), a local area network (LAN), or the Internet, among others. An external computing device may connect to the computer system 600 through the network 612. In some examples, an external computing device may be an external webserver or a cloud computing node.

It is to be understood that the block diagram of FIG. 6 is not intended to indicate that the computer system 600 is to include all of the components shown in FIG. 6. Rather, the computer system 600 can include any appropriate fewer or additional components not illustrated in FIG. 6 (e.g., additional memory components, embedded controllers, modules, additional network interfaces, etc.). Further, the embodiments described herein with respect to computer system 600 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

What is claimed is:

1. A computer-implemented method for determining a count of triangles (TR) in a graph data structure using a crosspoint array, the computer-implemented method comprising:
mapping, by a computer, to the crosspoint array, an adjacency matrix (A) that represents at least a portion of a graph data structure, wherein the crosspoint array comprises a plurality of crosspoint devices respectively corresponding to a plurality of values in the adjacency matrix, and the mapping comprises configuring resistance value of a crosspoint device according to a value at a corresponding position in the adjacency matrix;
setting, by the computer, the count of triangles in the graph data structure to zero (TR=0); and
updating, by the computer, the count of triangles using the crosspoint array, the updating comprises:
generating, by the computer, a first voltage vector (Vi) using a stochastic operation, the first voltage vector comprising a plurality of voltage values;
computing, by the computer, a multiplication of the adjacency matrix and the first voltage vector by applying the voltage values from the first voltage vector as input to the crosspoint array, wherein the result of the multiplication is a second voltage vector (Z₁=AV₁);
computing, by the computer, a multiplication of the adjacency matrix and the second voltage vector (Z₂=AZ₁) by applying the voltage values from the second voltage vector as input to the crosspoint array; and
updating, by the computer, the count of triangles in the graph data structure as TR=TR+Z₁^{T}Z₂/6.

2. The computer-implemented method of claim 1, wherein the computer repeats the updating of the count of triangles in the graph data structure for at least a predetermined number of iterations.

3. The computer-implemented method of claim 2, wherein the computer determines the count of triangles in the graph data structure as TR/number of iterations.

4. The computer-implemented method of claim 1, wherein the first voltage vector has the same length as the number of nodes in the graph data structure.

5. The computer-implemented method of claim 1, wherein the crosspoint array comprises:
a plurality of row wires; and
a plurality of column wires, wherein, a crosspoint device from the plurality of crosspoint devices is at each intersection of the row wires and the column wires.

6. The computer-implemented method of claim 1, wherein the result of the multiplication from the crosspoint array is in the form of a vector comprising electric current values.

7. The computer-implemented method of claim 1, wherein the count of triangles in the graph data structure is used to compute a clustering coefficient and/or a transitivity ratio.

8. A system for determining a number of triangles (TR) in graph data structures, the system comprising:
a crosspoint array; and
a computer coupled with the crosspoint array, the computer configured to perform a method comprising:
mapping to the crosspoint array, an adjacency matrix (A) that represents at least a portion of a graph data structure, wherein the crosspoint array comprises a plurality of crosspoint devices respectively corresponding to a plurality of values in the adjacency matrix, and the mapping comprises configuring resistance value of a crosspoint device according to a value at a corresponding position in the adjacency matrix;
setting a count of triangles in the graph data structure to zero (TR=0); and
updating the count of triangles using the crosspoint array, the updating comprises:
generating, by the computer, a first voltage vector (V₁) using a stochastic operation, the first voltage vector comprising a plurality of voltage values;
computing, by the computer, a multiplication of the adjacency matrix and the first voltage vector by applying the voltage values from the first voltage vector as input to the crosspoint array, wherein the result of the multiplication is a second voltage vector (Z₁=AV₁);
computing using the crosspoint array, a multiplication of the adjacency matrix and the second voltage vector (Z₂=AZ₁) by applying the voltage values from the second voltage vector as input to the crosspoint array; and
updating the count of triangles in the graph data structure as TR=TR+Z₁^{T}Z₂/6.

9. The system of claim 8, wherein the computer repeats the updating of the count of triangles in the graph data structure for at least a predetermined number of iterations.

10. The system of claim 9, wherein the computer determines the count of triangles in the graph data structure as TR/Number of iterations.

11. The system of claim 8, wherein the first voltage vector has the same length as the number of nodes in the graph data structure.

12. The system of claim 8, wherein the crosspoint array comprises:
a plurality of row wires; and
a plurality of column wires, wherein, a crosspoint device from the plurality of crosspoint devices is at each intersection of the row wires and the column wires.

13. The system of claim 8, wherein the result of the multiplication from the crosspoint array is in the form of a vector comprising electric current values.

14. The system of claim 8, wherein the count of triangles in the graph data structure is used to compute a clustering coefficient and/or a transitivity ratio.

15. A computer program product comprising a memory device having computer-executable instructions stored thereon, the computer-executable instructions when executed by one or more processing units cause the one or more processing units to perform a method for determining a number of triangles (TR) in a graph data structures, the method comprising:
mapping to a crosspoint array, an adjacency matrix (A) that represents at least a portion of a graph data structure, wherein the crosspoint array comprises a plurality of crosspoint devices respectively corresponding to a plurality of values in the adjacency matrix, and the mapping comprises configuring resistance value of a crosspoint device according to a value at a corresponding position in the adjacency matrix;
setting a count of triangles in the graph data structure to zero (TR=0); and
updating the count of triangles using the crosspoint array, the updating comprises:
generating, by the computer, a first voltage vector (V₁) using a stochastic operation, the first voltage vector comprising a plurality of voltage values;
computing, by the computer, a multiplication of the adjacency matrix and the first voltage vector by applying the voltage values from the first voltage vector as input to the crosspoint array, wherein the result of the multiplication is a second voltage vector (Z₁=AV₁);
computing using the crosspoint array, a multiplication of the adjacency matrix and the second voltage vector (Z₂=AZ₁) by applying the voltage values from the second voltage vector as input to the crosspoint array; and
updating the count of triangles in the graph data structure as TR=TR+Z₁^{T}Z₂/6.

16. The computer program product of claim 15, wherein the computer repeats the updating of the count of triangles in the graph data structure for at least a predetermined number of iterations.

17. The computer program product of claim 16, wherein the computer determines the count of triangles in the graph data structure as TR/Number of iterations.

18. The computer program product of claim 15, wherein the first voltage vector has the same length as the number of nodes in the graph data structure.

19. The computer program product of claim 15, wherein the crosspoint array comprises:
a plurality of row wires; and
a plurality of column wires, wherein, a crosspoint device from the plurality of crosspoint devices is at each intersection of the row wires and the column wires.

20. The computer program product of claim 15, wherein the result of the multiplication from the crosspoint array is in the form of a vector comprising electric current values.
